(19) United States
(12) Patent Application Publication
(10) Pub. No.: US 2003/0030623 A1
(43) Pub. Date: Feb. 13, 2003

(54) Collapsible keyboard

(76) Inventor: Ching-Chiang Yu, Keelung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/925,458

(22) Filed: Aug. 10, 2001

(51) Int. Cl. G09G 5/00

(52) U.S. Cl. 345/168

(57) ABSTRACT

A collapsible keyboard, comprising a center keyboard unit, a left keyboard unit, a right keyboard unit, and a base. Between the left and right keyboard units and the center keyboard unit are connecting members to join them together as one unit. The left and right keyboard units joined to the sides of the center keyboard unit can be folded along the sides of the center keyboard unit. The base serves to accommodate the collapsed keyboard, saving space for storage when the keyboard is not in use.

### BACKGROUND OF THE INVENTION

1. Field of the invention

This invention relates to a collapsible keyboard, particularly to a keyboard that is divided in a number of parts that can be joined as one unit or collapsed for storage. A base is served to accommodate the entire keyboard after it is collapsed, thereby minimizing the space and changing the shape required for storage.

2. Background of the invention

Conventional keyboard, especially that of desktop computer, occupies a large space. Designers design the keyboard aiming at the styling of the keyboard, making it look more beautiful, satisfy the requirement of ergonomics, and enhance its applicability. Furthermore, the designer also takes into consideration the keyboard keys, with the view of providing a maximum number of keys within a minimum space, and reducing the number of push key components. Until the present, however, we have not seen a better idea for collapsible keyboard design.

### SUMMARY OF THE INVENTION

The primary objective of the invention is to provide a collapsible keyboard, comprising a center keyboard unit, a left keyboard unit and a right keyboard unit, respective keyboard units being joined or collapsed, enabling a variety of keyboard styling configuration and reducing much space for storage purpose.

The second objective of the invention is to provide a collapsible keyboard that further comprises a base to accommodate the collapsed keyboard, the collapsed keyboard and the base forming a beautiful decoration instead of a rigid, machine-like image.

The drawings of preferred embodiments of this invention are described in following details to enable better understanding of the technical approaches of the invention.

### BRIEF DESCRIPTION OF THE DRAWINGS

FIG. 1 is a perspective view of the first embodiment of the invention.

FIG. 2 is a side view of the first embodiment of the invention, showing the keyboard is collapsed.

FIG. 3 is a perspective view of the first embodiment of the invention, showing the collapsed keyboard accommodated in a base.

FIG. 4 is a perspective view of the second embodiment of the invention.

FIG. 5 is a side view of the second embodiment of the invention, showing the keyboard is collapsed.

FIG. 6 is a perspective view of the second embodiment of the invention of collapsible keyboard, showing the collapsed keyboard accommodated in a base.

FIG. 7 is a perspective view of the third embodiment of the invention.

FIG. 8 is a side view of the third embodiment of the invention, showing the keyboard is collapsed.

FIG. 9 is a perspective view of the third embodiment of the invention, showing the collapsed keyboard accommodated in a base.

### DETAILED DESCRIPTION OF PREFERRED EMBODIMENTS

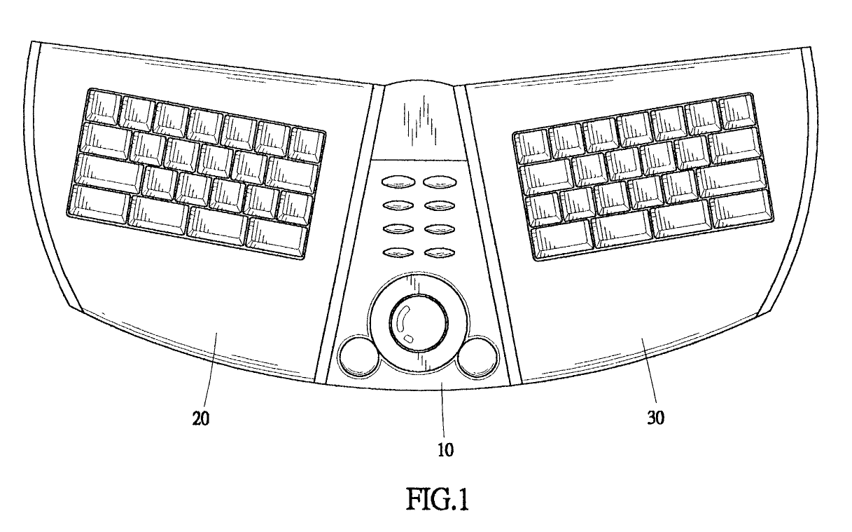

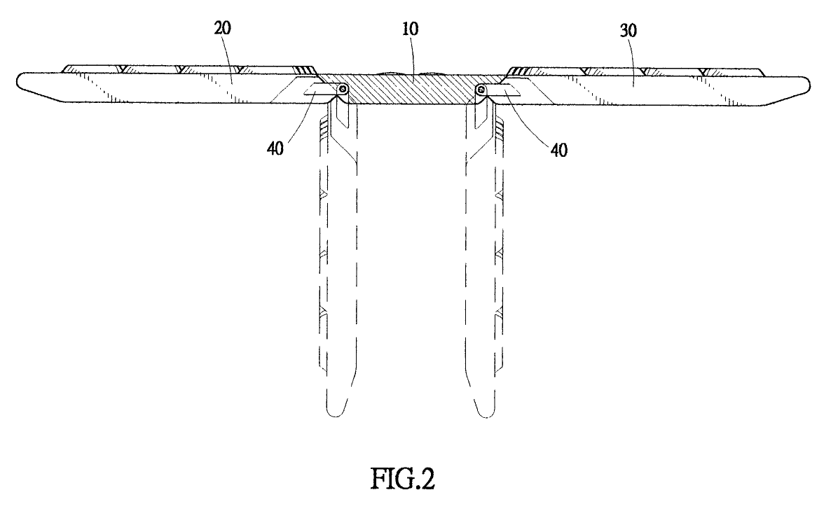

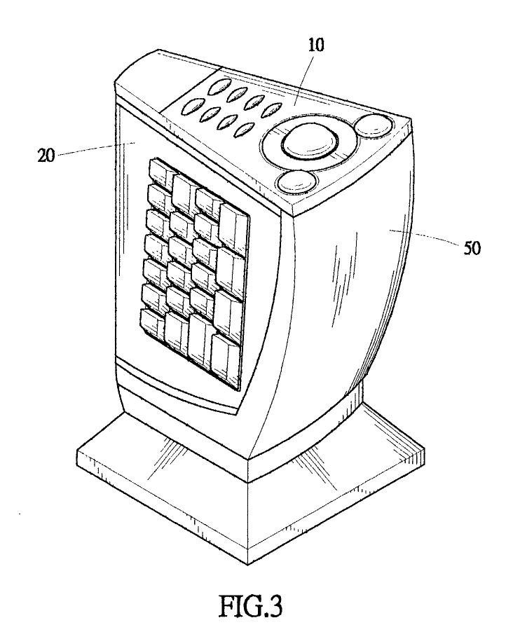

As shown in FIGS. 1, 2 and 3, the collapsible keyboard of the invention comprises a center keyboard unit 10, a left keyboard unit 20 and a right keyboard unit 30. The left and right keyboard units 20, 30 are located at the left side and right side of the center keyboard unit 10, with connecting members 40 joining the center keyboard unit 10 with the left and right keyboard units 20, 30. The connecting member 40 is a hinge, so that the left and right keyboard units 20, 30 will be folded along the sides of the center keyboard unit 10 to reduce the space for storage.

The collapsible keyboard further comprises a base 50. Basically, the upper part of the base 50 is a hollow space to accommodate the keyboard after collapsed, thereby reducing the space to be occupied for storage and providing a beautifully styled configuration. The keyboard can become a beautiful decorative item, instead of a rigid, machine-like monotone.

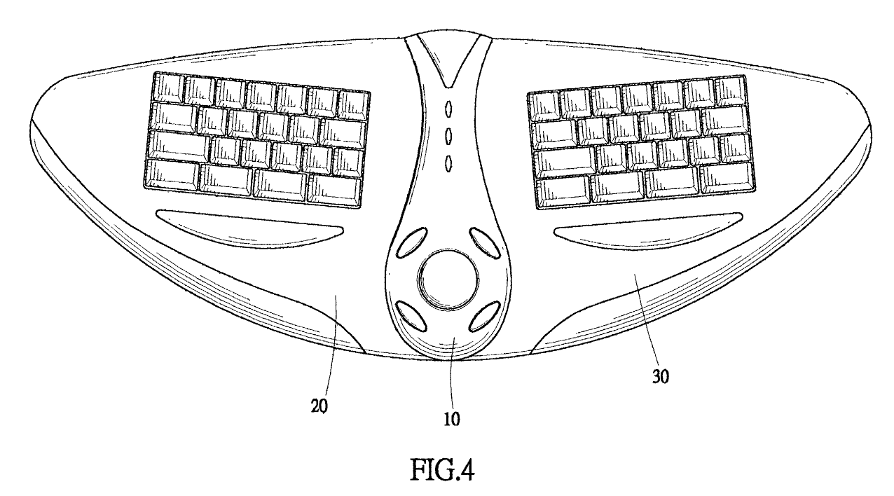

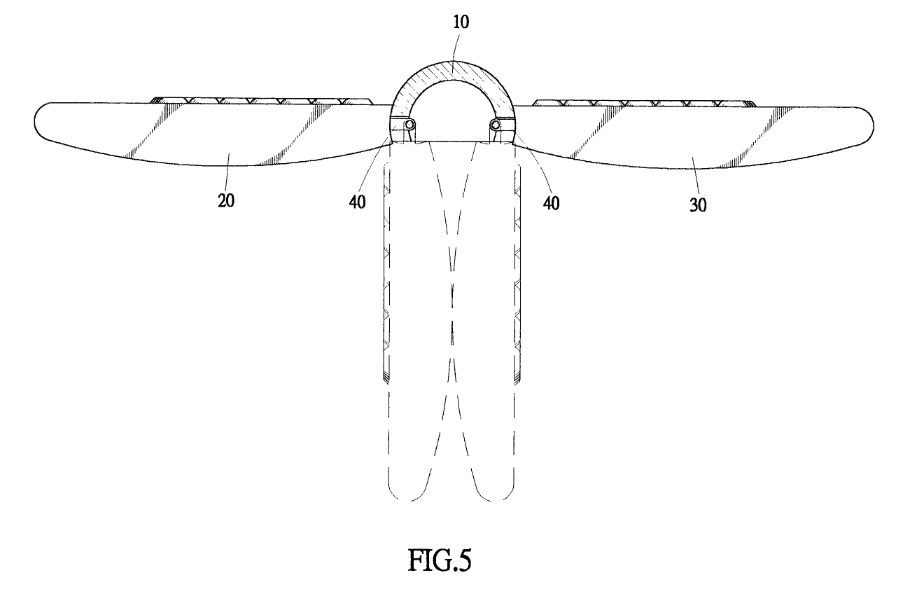

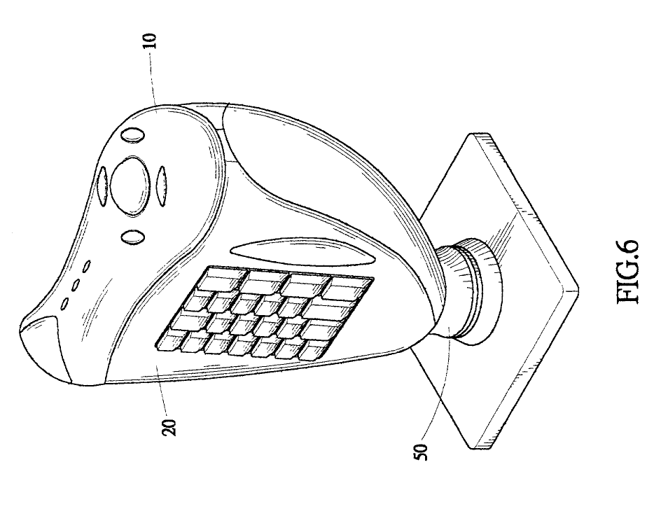

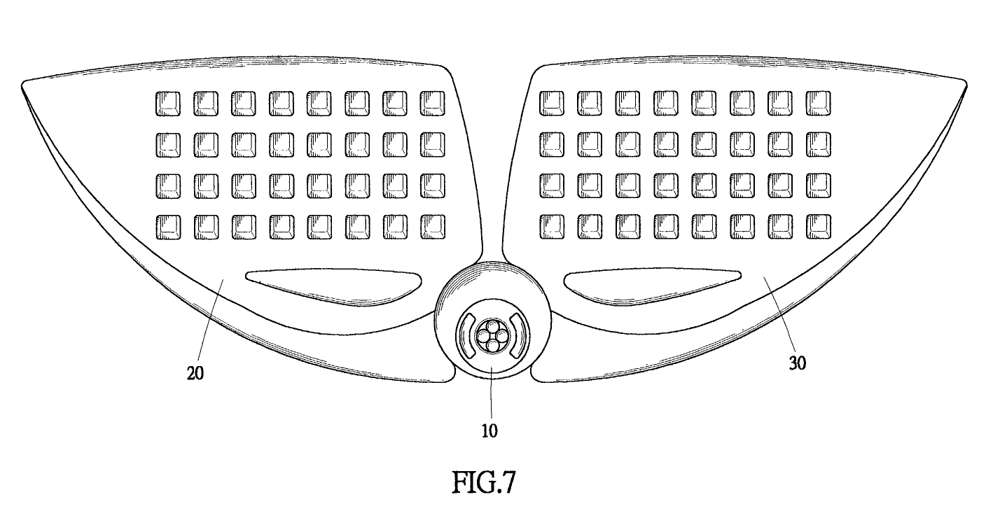

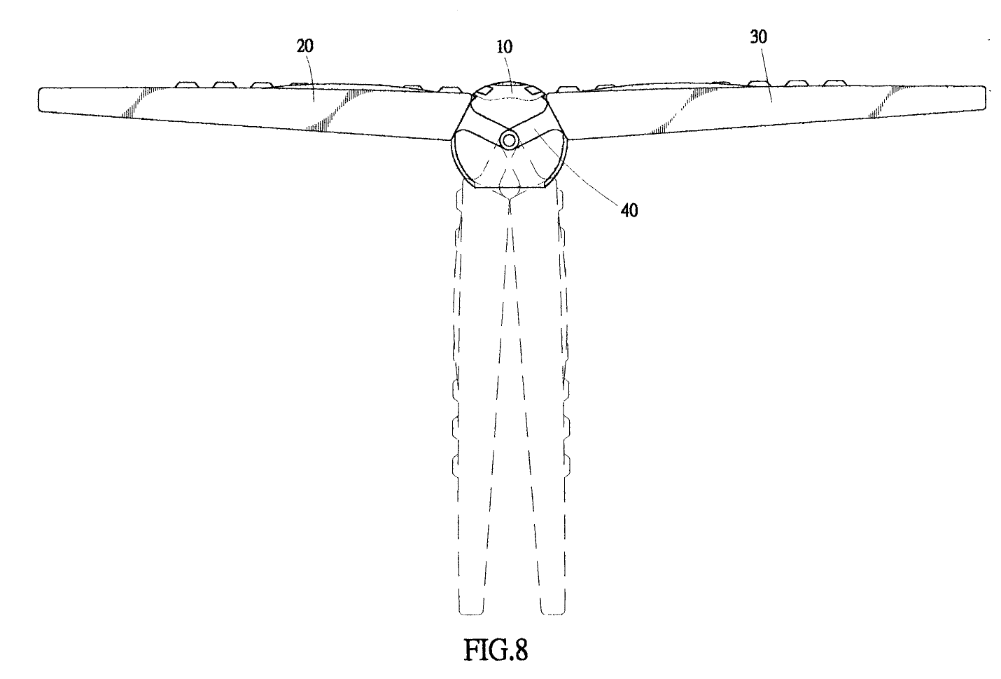

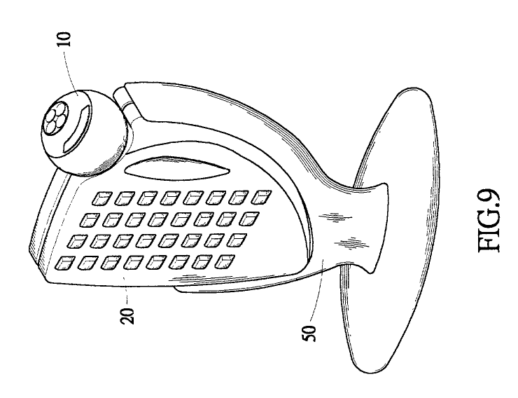

FIGS. 4 through 6 and 7 through 9 respectively show the second and third embodiments of the invention. With an emphasis in the design of the center keyboard unit 10 in three dimensions, while the left and right keyboard units 20, 30 are styled to match the center keyboard unit 10, with connecting members 40 joining them together. After the left and right keyboard units 20, 30 are folded along the sides of the center keyboard unit 10, the collapsed keyboard that can be designed in a wide variety of styling configurations is mounted on the base 50.

Though the invention is presented with the embodiments of a three-piece assembly, the assembly of more than three pieces is also applicable to the same effect. The aforementioned preferred embodiments shall not be based to restrict or limit the claim of the invention, which shall include change of number of components or other equivalent replacements or modifications of components.

What is claimed is:

1. A collapsible keyboard, comprising a center keyboard unit, a left keyboard unit and a right keyboard unit, the left and right keyboard units being located respectively at the left and right sides of the center keyboard unit, with connecting members located between the center keyboard unit and the left and right keyboard units, so the left and right keyboard units can be folded along the sides of the center keyboard unit.

2. The collapsible keyboard as claimed in claim 1, wherein the connecting member is a hinge.

3. The collapsible keyboard as claimed in claim 1, further comprising a base to accommodate the collapsed keyboard.

4. The collapsible keyboard as claimed in claim 3, wherein the upper part of the base is a hollow space to accommodate the collapsed keyboard.
